(19) United States
(12) Patent Application Publication
(10) Pub. No.: US 2016/0225284 A1
(43) Pub. Date: Aug. 4, 2016

(54) Intelligent Meal Planning Tool

(71) Applicants: Don Schoen, West Des Moines, IA (US); Davin Hills, West Des Moines, IA (US)

(72) Inventors: Don Schoen, West Des Moines, IA (US); Davin Hills, West Des Moines, IA (US)

(73) Assignee: BETTRLIFE CORPORATION, Urbandale, IA (US)

(21) Appl. No.: 14/997,741

(22) Filed: Jan. 18, 2016

Related U.S. Application Data
(63) Continuation-in-part of application No. 14/248,866, filed on Apr. 9, 2014, now abandoned.

(51) Int. Cl. G09B 19/00; G09B 5/02

(52) U.S. Cl. CPC G09B 19/0092; G09B 5/02

(57) ABSTRACT

A planning tool providing a communication and recording platform for nutrition coaches and those they coach is provided. The tool uses cognitive tools to create nutrition and activity plans and record consumption and activity. Specifically, the tool creates a meal plan based on user nutritional needs, distributing the plan to the user and accepting recorded consumption from the user; the user can tailor based on preferences. The tool creates the meal plan in accordance with particular nutritional values and is equipped to provide users with acceptable equivalent alternative food items to accomplish the goals. The tool allows the coach to amend the plan and facilitates communication between coach and users.

### PRIORITY STATEMENT

This application is a nonprovisional application and a continuation in part of U.S. Ser. No. 14/248,866 which was based on provisional application No. 61/809,932 which was filed Apr. 9, 2013 with the U.S. Patent and Trademark Office, the entire contents of which are incorporated herein.

### FIELD OF THE INVENTION

The present invention addresses the use of a combination of cognitive tools such as concept tagging, keyword extraction and sentiment analysis to derive detailed nutrition and activity plans. These plans can be automatically or manually “pushed” to individuals meeting specific dietary or exercise requirements and the user may record consumption and activity.

### BACKGROUND OF THE INVENTION

The relationship between health and dietary intake has never been clearer than it is today. With medical knowledge comes the awareness that a variety of health issues may be addressed, managed or even counter-acted by carefully managed nutritional intake. Further, with our ever-present focus on physical fitness which includes work-out routines, the link between nutritional intake and physical fitness activities and goals becomes clearer.

The current internet contains a huge collection of information relating to diet and exercise. Blogs, articles, lectures, journal articles are publicly accessible but often not actionable. Using cognitive tools these resources can be categorized, filtered and converted to a form that can be either directly or with minimal intervention used as nutritional or activity guidance.

A health coach may also participate in a medical team approach to assisting someone with needs related to dietary intake for the purpose of boosting immune response, or lowering cholesterol, or managing blood pressure. Health coaches often play a role in diabetic management or management of any number of other disease states or even for pre- and post-surgery diet needs. There is certainly a place for a health coach relative to weight management.

Health coaches typically take on a role that involves monitoring the compliance of the people using the dietary and activity plans.

Following a meal plan can be daunting. Unless tailored specifically to an individual (which would be a very expensive service indeed) such a meal plan often includes foods the individual does not like or does not like to prepare or cannot be obtained by the individual. Or requires items that cannot be readily supplemented by menu items at a restaurant. These problems often result in non-compliance. Where a diet is specially designed to include various nutrients or nutritional profiles, non-compliance can be very detrimental to the overall success of the person for whom the diet was designed.

A person wishing to manage his diet relative to a particular goal is likely to purchase a book that purports to include an effective diet. The book is geared toward the “average” person who wants to achieve that dietary goal but may not be appropriate or effective—or may be detrimental to—the person who purchased the book. For example, a person allergic to nuts would have to substitute for all ingredients that call for nuts; that substitution may not, then, include the same level of proteins that nuts would have contributed and, therefore, the intake has been altered.

What was needed was a tool that could automate the design and customization of a dietary and activity plan for a particular group of individuals. What was also needed was a tool that would allow the individuals in the dieting group to select from equivalents substitutes from the level of ingredients in a recipe to a substitute food item. Also desirable was a tool that could recommend several different equivalent commercial brands of a food item. Further, for the safety of the users, a tool that includes means for monitoring ingredients in the recommended foods on a particular diet relative to the users specific needs e.g. warnings for allergens, sugars, certain food dyes, etc., would offer high utility. Finally, a tool that allows the health coach to communicate with the user regarding successes and failures, and to provide suggestions for success, would be advantageous.

### SUMMARY OF THE INVENTION

The present invention comprises a planning tool for the development and provision of meal plans for groups of individuals. The power and uniqueness of the tool stem from its automation, flexibility, unique delivery method and monitoring capabilities.

FIG. 1 depicts a basic workflow that combines information related to diet, exercise and nutrition, the goal or target of a use, and a set of meal and activity plans.

Many diets exist with a variety of meal plans associated with them. They differ in nutritional focus. One diet may focus on fat or calories while another may focus on carbohydrate intake, and a third may be intended to control sugar intake for a chronic condition such as diabetes.

The tool of the present invention allows all of the above-mentioned plans to be built, distributed, and monitored via a single tool.

The tool's usage can be described an understood as follows:

Step 1. System Creates a Meal Plan Based on Nutritional Needs

System gives a meal plan a name and selects an indicator regarding whether the diet repeats. Typically, the meal plan will be assigned to a group of clients with related nutritional needs. For example, a diabetic group.

Step 2. System Defines Plan/Diet Phases by Time and Content

Phases of a particular diet are set up by assigning a specified number of days for each phase. For example, the first phase lasts for 6 days and a second phase lasts for 1 day.

Each phase can have a daily nutritional value, e.g., 1800 calories per day and less than 3200 mg Sodium. This can then be distributed throughout a day's meals by percentage or some other relative measurement.

Instead of, or in addition to nutrition values for a day and/or per meal, each meal can be defined using Food Tags. For example, breakfast in a particular diet requires 1 Cereal, and 1 Juice where “Cereal” is a tag and “Juice” is a tag. These tags represent a set of products, recipes and/or restaurant menu items e.g., the cereal tag contains (Cheerios and Wheaties) resident on a table and/or in a relational database stored in the system or some other list of cereals for this particular diet from which the user can choose. The use of relational database(s) provides means to associate data based on categories, statuses, etc. Tags may also include links to acceptable recipes for food items that meet the nutritional criteria for that meal. Finally, tags may include specific menu items at particular restaurants providing even more flexibility.

Further, the system might provide and prescribe specific nutritional guidelines for a day, both by minimum and maximum values, and recommended division of those values through a specified number of meals and/or snacks. As an example, a program that accepts the user's weight, age, sex and activity level may apply a set of criteria to recommend a nutritional program based on a goal set by the user. As an example, the system may recommend and set up a program that comprises 1800 calories per day with minimum protein of 50 grams, maximum fat of 65 grams, and maximum carbohydrates of 300grams which is distributed at 25% for breakfast, 15% morning snack, 25% for lunch, 10% for afternoon snack, 25% dinner. The number of calories might be set according to a calculation that takes into account the user's weight, age, sex and activity level or may be determined in accordance with a set ratios of fat/protein/carbs. In any event, the diet may be set forth by providing list of suggested specified foods identified by food tags. If the user does not wish to use the food specifically identified by the tag, he may select any of the equivalents/substitutes associated with the food tag.

Step 3. Coach Pushes the Meal Plan to the User

Typically, the system communicates the diet requirements to a group of individuals or to an individual via email, web application, or mobile application or a combination of these methods.

Step 3a. System identifies user nutritional requirements

As described above, using sets of user metrics, the system can identify meal and activity plans appropriate to a users requirements. Example metrics could be age, weight, BMI, etc. Coach may adjust.

Step 4. User May Tailor the Meal Plan

Once the diet is delivered to the user (or the user accesses the diet) the user may follow the diet either verbatim, or by selecting from the listed items that correspond with a particular tag. The user may also elect to start the diet today or a day in the future, and set a start date for a different specified meal plan in a given number of days.

Alternatively, the system may allow the user to input a particular food item (perhaps along with certain nutritional data)and request the system to determine whether that food item may be used as a substitute for one that was recommended or specified by the coach for a particular meal. In yet another embodiment, a user can be provided daily nutritional guidelines and the user may design his/her own meal plans by choosing food items from lists and/or databases; the system will analyze the choices and return information that tells the user which aspects of the coach's recommendations are not being met. In yet another embodiment, the tool may then check the user's selected food item against a database to generate and recommend specific food items that would allow the user to comply with the coach's recommendations for that diet, preferably with the minimal disruption to the meal plan constructed by the user.

Step 5. User records consumption

Step 6. Coach reviews user's recorded activities. May elect to comment, encourage, provide suggestions, or otherwise communicate with the group or with an individual user.

Other Features of the system include: The tool is equipped with a smart search tool which allows both coach and users to filter products, recipes and restaurant menu items by the nutritional guidelines set for a particular meal plan.

The tool is preferably also equipped with means for the coach (or the user) to record allergens, dislikes, or specific foods or ingredients to avoid in a profile. When the meal plan is pushed to a particular group, each profile of each user in the group is run against the meal plan and an indicator (e.g. red flag) appears next to a particular food item that contains an ingredient to be avoided by that user. The users can then select another food item as a substitute in accordance with the aforementioned disclosure.

To pull the above description together into a coherent picture the following example is provided: The coach designs a meal plan for a particular group with common dietary goals, restrictions or objectives. The user receives the meal plan, for example, a meal plan named “Low Fat Diet”. The meal plan defines a breakfast of cereal and juice that lasts for 6 days. This is followed by a single day that the user can eat whatever they wish. This pattern is then repeated indefinitely. The user wants to know which cereals are acceptable and at what amounts and selects the tag “cereal”. Five cereals are returned as acceptable substitutes, but one includes a red flag because the user is allergic to strawberries and the particular cereal includes dried strawberries. The user selects one of the other four cereals, and records the amount consumed along with the volume of milk.

For lunch the meal plan calls for one of several sandwiches on whole wheat bread. The user is planning to have lunch at a well-known chain restaurant and wants to know whether the club sandwich there might be substituted. The user selects the turkey and cheese sandwich from the meal planner and selects a restaurant and the club sandwich there. The tool returns a message that this sandwich includes too much fat, but suggests removing cheese from the sandwich to meet the meal plan requirements. For dinner, the meal plan suggests pasta and grilled vegetables; this item includes a red flag because the user is allergic to tomatoes. The user selects this food item and a list of acceptable substitutes is returned. The user selects one of these and the recipe is provided.

After each meal, or at the end of a day, the user records the food items consumed. If he has questions, he may post them for the health coach via one of several types of messaging regimes that can be incorporated into the tool. The health coach can respond to these questions. Alternatively, the health coach may monitor the user's intake and provide comments, suggestions, or even encouragement via the associated messaging tool.

Much more complex meal plans can build around things like pre- and post-surgery diets. For example, it might contain 30 days of specific meals leading up to the surgery and an all-liquid diet for 10 days after and then end.

FIG. 3 provides a screenshot of the health coach meal planning setup screen. The top shows the naming of a meal plan. Farther down the coach can define phases (in the screen we refer to them as periods but the name has since been changed) and then define how long the phase is and what it should include for nutrition and specific meal content.

In order for the system to work as described, several databases (or a relational database) are employed. These databases include food items and every ingredient in each food item as well as specific nutritional characteristics of that item on a per serving basis along with a measurement of a serving; recipes for food items that list quantities and each ingredient, along with directions for preparation. And may include lists containing restaurant menu items and associated information about their nutritional values, which values are becoming more and more available.

Assigning to a Group

After building a meal plan a health coach can assign it to multiple groups of consumers. E.g. Assign “Low Fat Diet” to my diabetic group that consists of 100 people.

Consumer Tool Usage

Meal plans assigned to consumers/patients will appear in the planning portion of the consumer application. They have the ability to review the plan, start a plan and stop a started plan.

FIG. 3 shows a list of meal plans assigned to a specific consumer/patient. From here the user can review all the meals and nutrition assigned to them by a health coach. The user can start or stop a plan.

FIG. 4 shows what a started plan will show the consumer. It lists the meals they should be eating, the nutrition of those meals and in the case of breakfast the specific items they should be eating. It also shows a small tracking bar to show their daily progress.

The graphic at FIG. 5 shows a meal plan after the consumer/patient has filled out his plan by recording what he has consumed. It will graphically indicate to the user items that fit the plan and items that did not fit the plan, as well as totals for the whole day.

If used in combination with an automated shopping list tool (most preferably one that includes an inventory tool for tracking used items from a user's pantry), the meal planner will run the inventory against ingredients or items necessary to create the selected meal plans, and then populate a shopping list with items from the meal plan, or ingredients from the recipes for items selected either by the health coach or by the user as a substitute for items recommended by the health coach.

The above description provides both a general and a more particularized description of features and functions that may be combined to create a meal planning tool of the present invention.

### BRIEF DESCRIPTION OF THE DRAWINGS

FIG. 1 is a schematic showing the various inputs for a meal plan

FIG. 2 is a schematic showing the cycle from creation of a meal plan to feedback from the health coach;

FIG. 3 is a screenshot of the meal planning setup screen

FIG. 4 is a screenshot showing a list of meal plans assigned to a user;

FIG. 5 shows the itemized nutrition plan and recorded intake relative to planned intake.

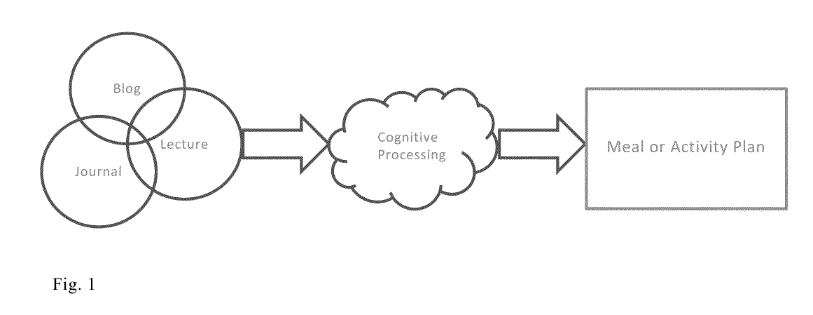

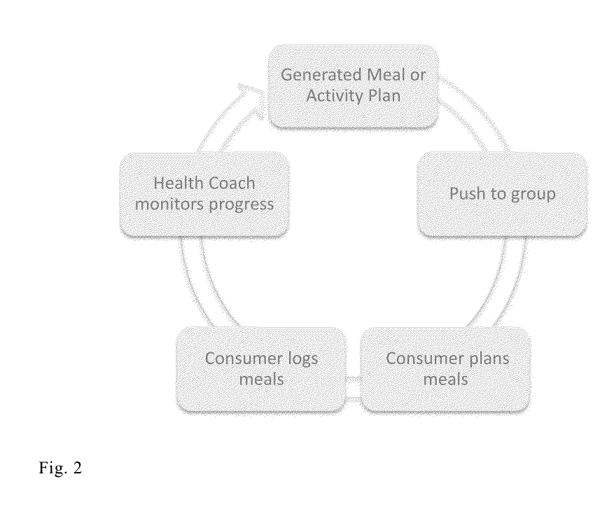

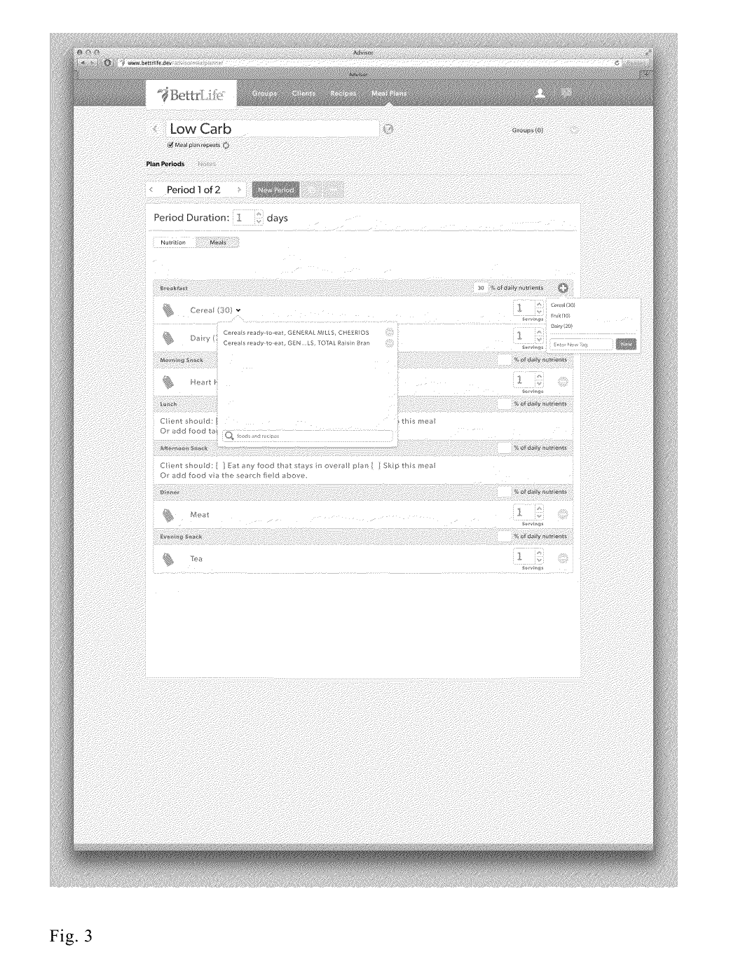

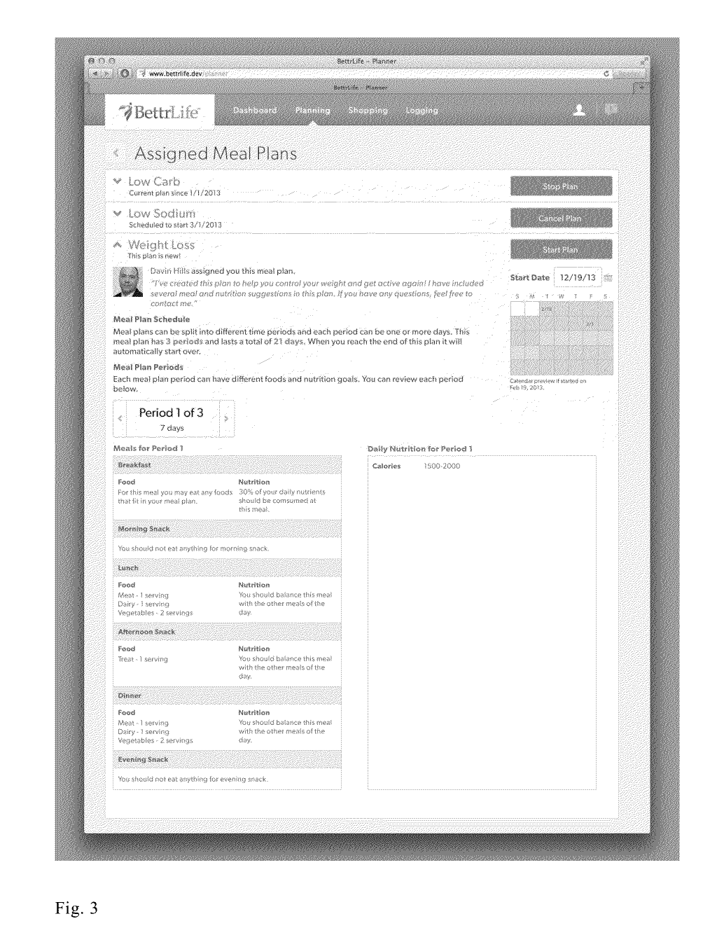

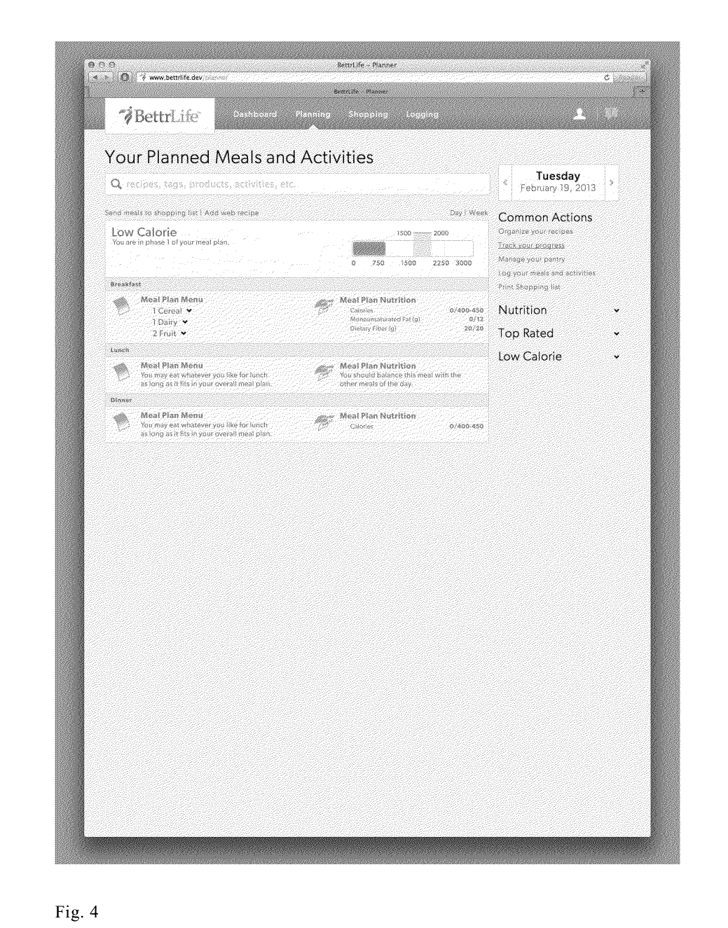

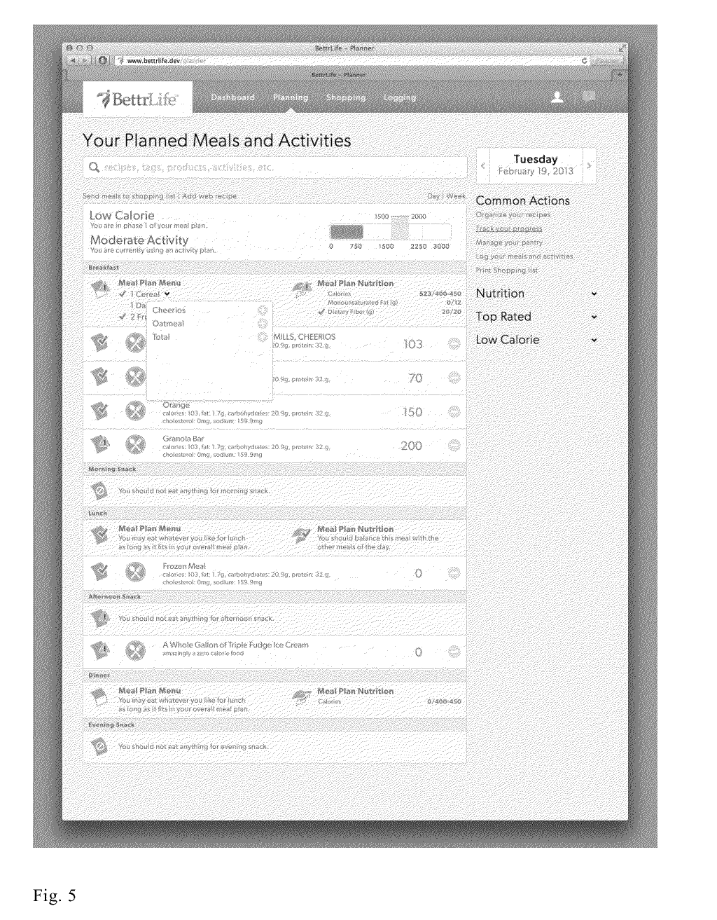

What we claim is:

1. A meal planning tool comprising means to create a meal plan for a particular group of people, said meal plan tailored to meet specific dietary objectives shared by the group wherein said tool allows the meal plan to be communicated via electronic means to each individual in the group.

2. The meal planning tool of claim 1 wherein said meal plan includes at least one food item, said food item identified by a tag, said tag associated with the food item and at least one of a brand name, recipe, and a common name considered by the meal plan to be an equivalent.

3. The meal planning tool of claim 2 wherein a user of said tool may substitute said at least one food item by selecting from the at least one of a brand name, recipe, or common name.

4. The meal planning tool of claim 1 or 3 wherein said user logs each food item he consumes whether or not said food item was part of the meal plan.

5. The meal planning tool of claim 4 wherein said tool provides a messaging tool for use by the user and a health coach.

6. The meal planning tool of claim 4 wherein said tool returns a report to the user indicating compliant and noncompliant food items consumed, and totals for specified nutritional metrics based on recorded consumption.
